(19) United States
(12) Patent Application Publication
(10) Pub. No.: US 2002/0063479 A1
(43) Pub. Date: May 30, 2002

(54) Active turbine combustion parameter control system and method

(75) Inventors: Mark Mitchell, Monrovia, CA (US); Jeffrey W. Willis, Los Angeles, CA (US); Guillermo Pont, Los Angeles, CA (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: CAPSTONE TURBINE CORPORATION, Chatsworth, CA (US)

(21) Appl. No.: 09/973,866

(22) Filed: Oct. 11, 2001

Related U.S. Application Data
(60) Provisional application No. 60/246,130, filed on Nov. 6, 2000.
(60) Provisional application No. 60/239,710, filed on Oct. 11, 2000.

(51) Int. Cl. H02J 1/00

(52) U.S. Cl. 307/153

(57) ABSTRACT

A turbogenerator having a compressor configured to compress a fuel oxidizer, a combustor connected to an exhaust of the compressor and configured both to receive the fuel oxidizer and a fuel and to combust the fuel and the fuel oxidizer into a combusted gas, a fuel supplier configured to control fuel droplet sizes of the fuel supplied into the combustor to prevent flameout of the turbogenerator, a turbine connected to an exhaust of the combustor and configured to convert heat from the combusted gas into rotational energy, a motor/generator configured to convert the rotational energy into electrical energy, and a common shaft connecting the turbine, the compressor, and the motor/generator. The common shaft is configured to rotate the turbine, the compressor, and the motor/generator. The turbogenerator is controlled by a process of compressing the fuel oxidizer, supplying to the fuel oxidizer a fuel at a controllable fuel droplet size to prevent flameout of the turbogenerator, combusting the fuel and the fuel oxidizer to produce combusted gases whose expulsion through a turbine generates turbine rotational energy, applying a rotational resistance to the turbine via the motor/generator, and controlling a rotational speed of the turbogenerator by varying a degree of the compressing, supplying, combusting, and applying steps.

### CROSS-REFERENCE TO RELATED APPLICATIONS

This patent application claims benefit of and priority to U.S. provisional application Serial No. 60/246,130 filed Nov. 6, 2000 and U.S. provisional application Serial No. 60/239,710 filed Oct. 11, 2000, and the entire contents of both provisionals are incorporated herein by reference.

### BACKGROUND OF THE INVENTION

1. Field of the Invention

This invention relates to the general field of combustion systems and methods, and more particularly to an improved combustion system for a liquid-fueled turbine engine.

2. Discussion of the Related Art

In a turbine engine, inlet air is continuously compressed, mixed with fuel in an inflammable proportion, and then contacted with an ignition source to ignite the mixture that will then continue to burn. The heat energy released from the combustion gases then flows in the combustion gases to a turbine where the heat energy is converted to rotary energy for driving equipment, such as for example an electrical generator. Before being exhausted to the atmosphere, the combustion gases exchange heat to incoming air entering the turbine engine.

In a liquid fuel system, a liquid fuel is fed through injector orifices or atomizers into a combustor. In the combustor, the liquid fuel is mixed with the incoming air. The injector orifices are relatively small. As the fuel is fed through the injectors, the fuel is atomized or dispersed into many small droplets. The atomization or dispersion provides for more complete and even mixing with the inlet air which in turn promotes efficient burning of the fuel, resulting in higher turbine efficiency and lower exhaust emissions. The injectors are usually designed for a normal (i.e. high) operating speed of the turbine and provide to the combustor an optimum fuel droplet size, yielding high turbine engine efficiencies and low exhaust emissions.

The inventors realized that, due to the optimization of the turbine for a set operating speed, when the speed of the turbine is reduced, the fuel-to-air ratio typically decreases, and the temperature of the fuel/air combustion reaction decreases. Below a certain turbine speed, the combustion reaction becomes unstable because the generated heat is not enough to sustain the combustion reaction. The turbine engine can then experience a flameout condition. The inventors further realized that what is needed is a technique to allow this operation close to the stability limits while avoiding flameout.

### SUMMARY OF THE INVENTION

One object of the present invention is to control emissions and stability in a turbine engine.

Another object of the present invention is to control the fuel droplet size injected into a combustor of a turbine engine, and thereby produce a wider of range of efficient operating conditions other than just operation at a normal speed.

Still, a further object of the present invention is to heat or cool the fuel supplied to the turbogenerator to control the fuel droplet size injected into the combustor of the turbine engine.

Another object of the present invention is to control the fuel droplet size by the strength of an electric field existing inside a region where the fuel droplets are injected.

These and other objects of the present invention are achieved in a novel turbogenerator having a compressor configured to compress a fuel oxidizer, a combustor connected to an exhaust of the compressor and configured both to receive the fuel oxidizer and a fuel and to combust the fuel and the fuel oxidizer into a combusted gas, a fuel supplier configured to control fuel droplet sizes of the fuel supplied into the combustor to prevent flameout of the turbogenerator, a turbine connected to an exhaust of the combustor and configured to convert heat from the combusted gas into rotational energy, a motor/generator configured to convert the rotational energy into electrical energy, and a common shaft connecting the turbine, the compressor, and the motor/generator. The turbogenerator is controlled by a process of compressing the fuel oxidizer, supplying to the fuel oxidizer a fuel with a controllable fuel droplet size to prevent flameout of the turbogenerator, combusting the fuel and the fuel oxidizer to produce combusted gases whose expulsion through a turbine generates turbine rotational energy, applying a rotational resistance to the turbine via the motor/generator, and controlling a rotational speed of the turbogenerator by varying a degree of the compressing, supplying, combusting, and applying steps.

Emissions and stability limits of a liquid-fueled turbine combustion system are determined by 1) the preparation of the fuel prior to atomization, 2) the degree of atomization of the fuel, 3) the degree of vaporization of the fuel, 4) the degree of mixing of the fuel with an oxidizer, and 5) the final combusted gas products resulting from a combustion of the fuel and the oxidizer. Active control of the emissions and stability of the turbogenerator of the present invention can be obtained by control of parameters influencing these steps. The benefits of active control include not only efficiency improvements and reduced emissions at non-normal turbine speeds, but also an improved range of operational speed in which low emissions and improved combustion stability margins are obtained.

Another object of the present invention is to provide a power generation and distribution system utilizing a turbine-powered generator with an efficient operational range and reduced emissions. This object is provided for by a novel power generation and distribution system including a turbogenerator having a compressor configured to compress a fuel oxidizer, a combustor connected to an exhaust of the compressor and configured both to receive the fuel oxidizer and a fuel and to combust the fuel and the fuel oxidizer into a combusted gas, a fuel supplier configured to control fuel droplet sizes of the fuel supplied into the combustor to prevent flameout of the turbogenerator, a turbine attached to an exhaust of the combustor and configured to convert heat from the combusted gas into rotational energy, a motor/generator configured to convert said rotational energy into electrical energy, and a common shaft connecting the turbine, the compressor, and the motor/generator. The power generation and distribution system connects the turbogenerator to an electrical load.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1A is perspective view, partially in section, of an integrated turbogenerator system;

FIG. 1B is a magnified perspective view, partially in section, of the motor/generator portion of the integrated turbogenerator of FIG. 1A;

FIG. 1C is an end view, from the motor/generator end, of the integrated turbogenerator of FIG. 1A;

FIG. 1D is a magnified perspective view, partially in section, of the combustor-turbine exhaust portion of the integrated turbogenerator of FIG. 1A;

FIG. 1E is a magnified perspective view, partially in section, of the compressor-turbine portion of the integrated turbogenerator of FIG. 1A;

FIG. 2 is a block diagram schematic of a turbogenerator system including a power controller having decoupled rotor speed, operating temperature, and DC bus voltage control loops;

FIG. 3 is a fuel injector according to the present invention;

FIG. 4 is a graph, according to the present invention, depicting fuel droplet distribution size as a function of turbine speed for different input heating of the fuel;

FIG. 5 is a graph, according to the present invention, depicting performance curves for nozzles with different orifices used separately and in combination;

FIG. 6 is a graph, according to the present invention, depicting a combined performance curve for nozzle size and input heat variation;

FIG. 7 is a flowchart depicting steps to be controlled in operating the turbogenerator of the present invention.

### DETAILED DESCRIPTION OF THE PREFERRED EMBODIMENTS

Various other objects, features and attendant advantages of the present invention will be more fully appreciated as the same becomes better understood from the following detailed description when considered in connection with the accompanying drawings in which like reference characters designate like or corresponding parts throughout the several views.

Mechanical Structural Embodiment of a Turbogenerator

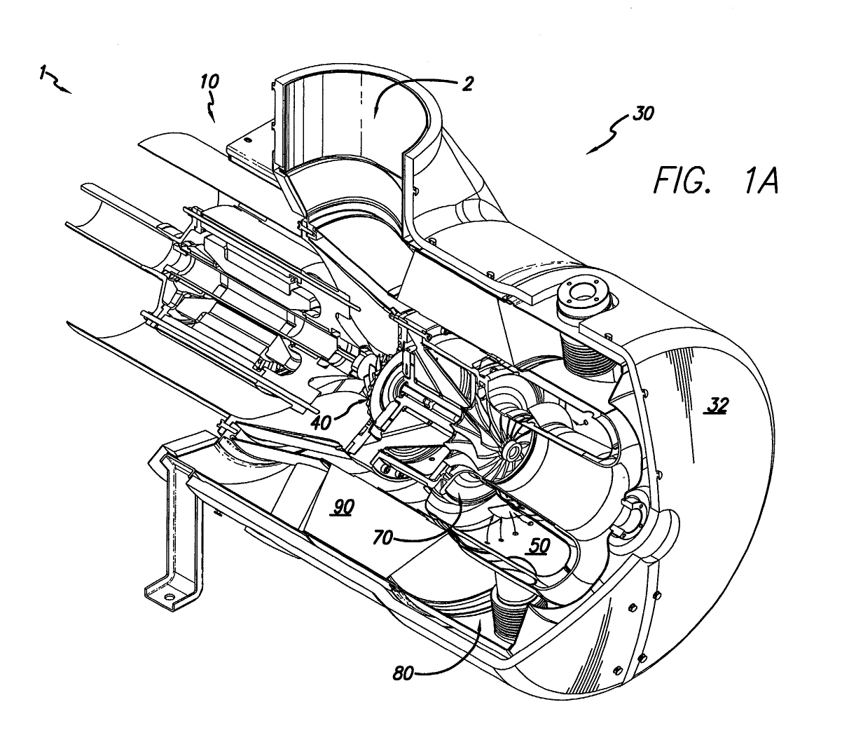

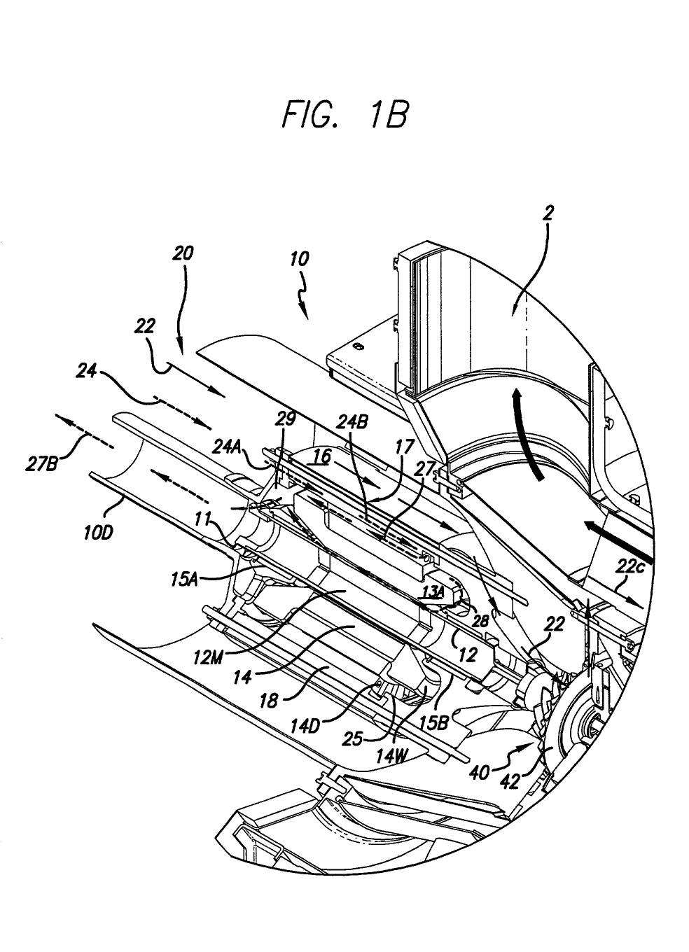

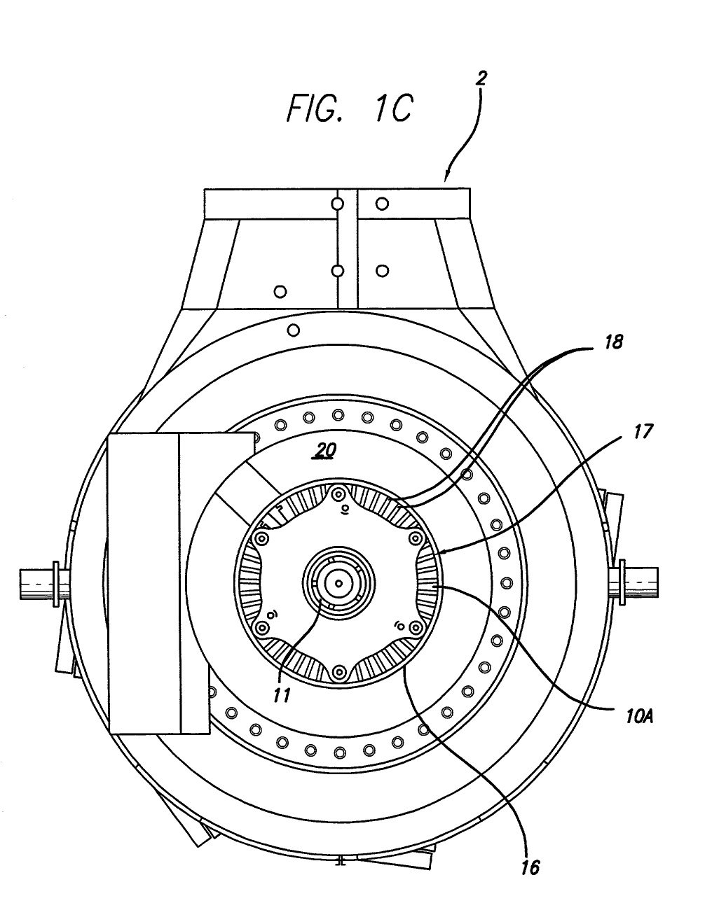

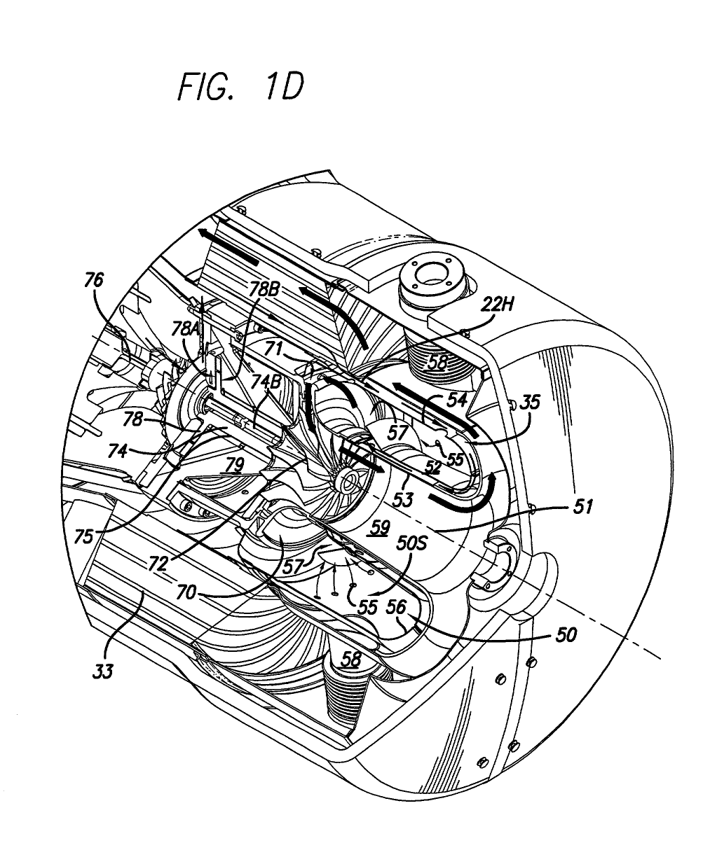

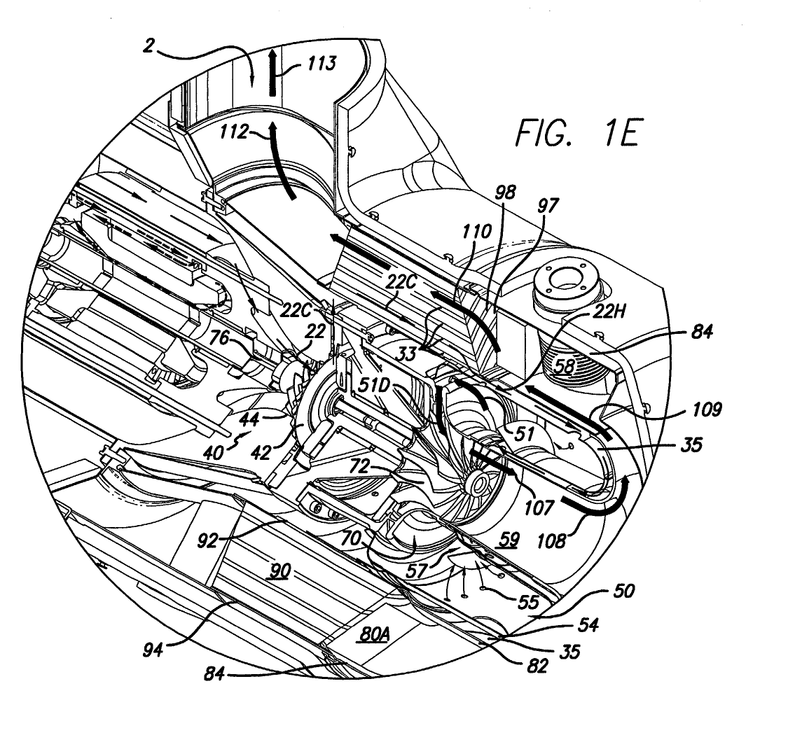

With reference to FIG. 1A, an integrated turbogenerator 1 according to the present invention generally includes motor/generator section 10 and compressor-combustor section 30. Compressor-combustor section 30 includes exterior can 32, compressor 40, combustor 50 and turbine 70. A recuperator 90 may be optionally included.

Referring now to FIG. 1B and FIG. 1C, in a currently preferred embodiment of the present invention, motor/generator section 10 may be a permanent magnet motor generator having a permanent magnet rotor or sleeve 12. Any other suitable type of motor generator may also be used. Permanent magnet rotor or sleeve 12 may contain a permanent magnet 12M. Permanent magnet rotor or sleeve 12 and the permanent magnet disposed therein are rotatably supported within permanent magnet motor/generator stator 14. Preferably, one or more compliant foil, fluid film, radial, or journal bearings 15A and 15B rotatably support permanent magnet rotor or sleeve 12 and the permanent magnet disposed therein. All bearings, thrust, radial or journal bearings, in turbogenerator 1 may be fluid film bearings or compliant foil bearings. Motor/generator housing 16 encloses stator heat exchanger 17 having a plurality of radially extending stator cooling fins 18. Stator cooling fins 18 connect to or form part of stator 14 and extend into annular space 10A between motor/generator housing 16 and stator 14. Wire windings 14W exist on permanent magnet motor/generator stator 14.

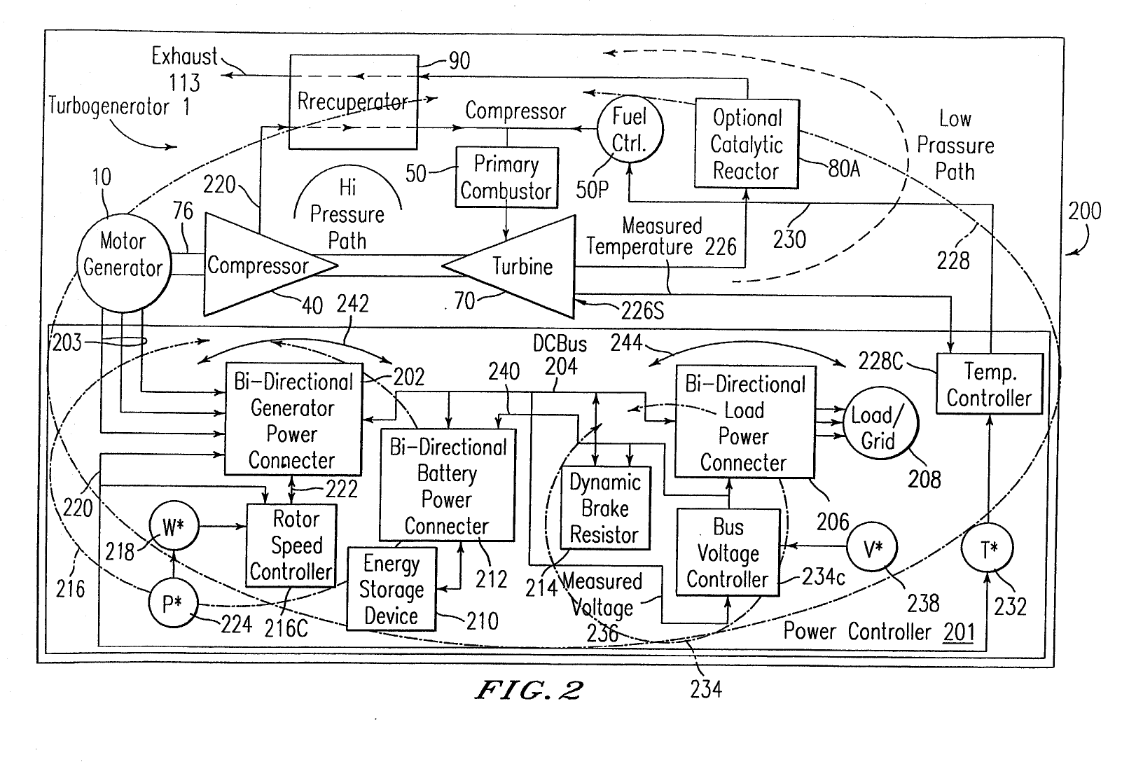

Referring now to FIG. 1D, combustor 50 may include cylindrical inner wall 52 and cylindrical outer wall 54. Cylindrical outer wall 54 may also include air inlets 55. Cylindrical walls 52 and 54 define an annular interior space 50S in combustor 50 defining an axis 51. Combustor 50 includes a generally annular wall 56 further defining one axial end of the annular interior space of combustor 50. Associated with combustor 50 may be one or more fuel injector inlets 58 to accommodate fuel injectors which receive fuel from fuel control element 50P as shown in FIG. 2, and inject fuel or a fuel air mixture to interior of 50S combustor 50. Inner cylindrical surface 53 is interior to cylindrical inner wall 52 and forms exhaust duct 59 for turbine 70.

Turbine 70 may include turbine wheel 72. An end of combustor 50 opposite annular wall 56 further defines an aperture 71 in turbine 70 exposed to turbine wheel 72. Bearing rotor 74 may include a radially extending thrust bearing portion, bearing rotor thrust disk 78, constrained by bilateral thrust bearings 78A and 78B. Bearing rotor 74 may be rotatably supported by one or more journal bearings 75 within center bearing housing 79. Bearing rotor thrust disk 78 at the compressor end of bearing rotor 76 is rotatably supported preferably by a bilateral thrust bearing 78A and 78B. Journal or radial bearing 75 and thrust bearings 78A and 78B may be fluid film or foil bearings.

Turbine wheel 72, bearing rotor 74 and compressor impeller 42 may be mechanically constrained by tie bolt 74B, or other suitable technique, to rotate when turbine wheel 72 rotates. Mechanical link 76 mechanically constrains compressor impeller 42 to permanent magnet rotor or sleeve 12 and the permanent magnet disposed therein causing permanent magnet rotor or sleeve 12 and the permanent magnet disposed therein to rotate when compressor impeller 42 rotates.

Referring now to FIG. 1E, compressor 40 may include compressor impeller 42 and compressor impeller housing 44. Recuperator 90 may have an annular shape defined by cylindrical recuperator inner wall 92 and cylindrical recuperator outer wall 94. Recuperator 90 contains internal passages for gas flow, one set of passages, passages 33 connecting from compressor 40 to combustor 50, and one set of passages, passages 97, connecting from turbine exhaust 80 to turbogenerator exhaust output 2.

Referring again to FIG. 1B and FIG. 1C, in operation, air flows into primary inlet 20 and divides into compressor air 22 and motor/generator cooling air 24. Motor/generator cooling air 24 flows into annular space 10A between motor/generator housing 16 and permanent magnet motor/generator stator 14 along flow path 24A. Heat is exchanged from stator cooling fins 18 to generator cooling air 24 in flow path 24A, thereby cooling stator cooling fins 18 and stator 14 and forming heated air 24B. Warm stator cooling air 24B exits stator heat exchanger 17 into stator cavity 25 where it further divides into stator return cooling air 27 and rotor cooling air 28. Rotor cooling air 28 passes around stator end 13A and travels along rotor or sleeve 12. Stator return cooling air 27 enters one or more cooling ducts 14D and is conducted through stator 14 to provide further cooling. Stator return cooling air 27 and rotor cooling air 28 rejoin in stator cavity 29 and are drawn out of the motor/generator 10 by exhaust fan 11 which is connected to rotor or sleeve 12 and rotates with rotor or sleeve 12. Exhaust air 27B is conducted away from primary air inlet 20 by duct 10D.

Referring again to FIG. 1E, compressor 40 receives compressor air 22. Compressor impeller 42 compresses compressor air 22 and forces compressed gas 22C to flow into a set of passages 33 in recuperator 90 connecting compressor 40 to combustor 50. In passages 33 in recuperator 90, heat is exchanged from walls 98 of recuperator 90 to compressed gas 22C. As shown in FIG. 1E, heated compressed gas 22H flows out of recuperator 90 to space 35 between cylindrical inner surface 82 of turbine exhaust 80 and cylindrical outer wall 54 of combustor 50. Heated compressed gas 22H may flow into combustor 54 through sidewall ports 55 or main inlet 57. Fuel (not shown) may be reacted in combustor 50, converting chemically stored energy to heat. Hot compressed gas 51 in combustor 50 flows through turbine 70 forcing turbine wheel 72 to rotate. Movement of surfaces of turbine wheel 72 away from gas molecules partially cools and decompresses gas 51D moving through turbine 70. Turbine 70 is designed so that exhaust gas 107 flowing from combustor 50 through turbine 70 enters cylindrical passage 59. Partially cooled and decompressed gas in cylindrical passage 59 flows axially in a direction away from permanent magnet motor/generator section 10, and then radially outward, and then axially in a direction toward permanent magnet motor/generator section 10 to passages 98 of recuperator 90, as indicated by gas flow arrows 108 and 109 respectively.

In an alternate embodiment of the present invention, low pressure catalytic reactor 80A may be included between fuel injector inlets 58 and recuperator 90. Low pressure catalytic reactor 80A may include internal surfaces (not shown) having catalytic material (e.g., Pd or Pt, not shown) disposed on them. Low pressure catalytic reactor 80A may have a generally annular shape defined by cylindrical inner surface 82 and cylindrical low pressure outer surface 84. Unreacted and incompletely reacted hydrocarbons in gas in low pressure catalytic reactor 80A react to convert chemically stored energy into additional heat, and to lower concentrations of partial reaction products, such as harmful emissions including nitrous oxides (NOx).

Gas 110 flows through passages 97 in recuperator 90 connecting from turbine exhaust 80 or catalytic reactor 80A to turbogenerator exhaust output 2, as indicated by gas flow arrow 112, and then exhausts from turbogenerator 1, as indicated by gas flow arrow 113. Gas flowing through passages 97 in recuperator 90 connecting from turbine exhaust 80 to outside of turbogenerator 1 exchanges heat to walls 98 of recuperator 90. Walls 98 of recuperator 90 heated by gas flowing from turbine exhaust 80 exchange heat to gas 22C flowing in recuperator 90 from compressor 40 to combustor 50.

Turbogenerator 1 may also include various electrical sensor and control lines for providing feedback to power controller 201 and for receiving and implementing control signals as shown in FIG. 2.

Alternative Mechanical Structural Embodiments of the Integrated Turbogenerator

The integrated turbogenerator disclosed above is exemplary. Several alternative structural embodiments are known.

In one alternative embodiment, air 22 may be replaced by a gaseous fuel mixture. In this embodiment, fuel injectors may not be necessary. This embodiment may include an air and fuel mixer upstream of compressor 40.

In another alternative embodiment, fuel may be conducted directly to compressor 40, for example by a fuel conduit connecting to compressor impeller housing 44. Fuel and air may be mixed by action of the compressor impeller 42. In this embodiment, fuel injectors may not be necessary.

In another alternative embodiment, combustor 50 may be a catalytic combustor.

In another alternative embodiment, geometric relationships and structures of components may differ from those shown in FIG. 1A. Permanent magnet motor/generator section 10 and compressor/combustor section 30 may have low pressure catalytic reactor 80A outside of annular recuperator 90, and may have recuperator 90 outside of low pressure catalytic reactor 80A. Low pressure catalytic reactor 80A may be disposed at least partially in cylindrical passage 59, or in a passage of any shape confined by an inner wall of combustor 50. Combustor 50 and low pressure catalytic reactor 80A may be substantially or completely enclosed with an interior space formed by a generally annularly shaped recuperator 90, or a recuperator 90 shaped to substantially enclose both combustor 50 and low pressure catalytic reactor 80A on all but one face.

Alternative Use of the Invention Other than in Integrated Turbogenerators

An integrated turbogenerator is a turbogenerator in which the turbine, compressor, and generator are all constrained to rotate based upon rotation of the shaft to which the turbine is connected. The invention disclosed herein is preferably but not necessarily used in connection with a turbogenerator, and preferably but not necessarily used in connection with an integrated turbogenerator.

Turbogenerator System Including Controls

Referring now to FIG. 2, a preferred embodiment is shown in which a turbogenerator system 200 includes power controller 201 which has three substantially decoupled control loops for controlling (1) rotary speed, (2) temperature, and (3) DC bus voltage. A more detailed description of an appropriate power controller is disclosed in U.S. patent application Ser. No. 09/207,817, filed Dec. 8, 1998 in the names of Gilbreth, Wacknov and Wall, and assigned to the assignee of the present application which is incorporated herein in its entirety by this reference.

Referring still to FIG. 2, turbogenerator system 200 includes integrated turbogenerator 1 and power controller 201. Power controller 201 includes three decoupled or independent control loops.

A first control loop, temperature control loop 228, regulates a temperature related to the desired operating temperature of primary combustor 50 to a set point, by varying fuel flow from fuel control element 50P to primary combustor 50. Temperature controller 228C receives a temperature set point, T*, from temperature set point source 232, and receives a measured temperature from temperature sensor 226S connected to measured temperature line 226. Temperature controller 228C generates and transmits over fuel control signal line 230 to fuel pump 50P a fuel control signal for controlling the amount of fuel supplied by fuel pump 50P to primary combustor 50 to an amount intended to result in a desired operating temperature in primary combustor 50. Temperature sensor 226S may directly measure the temperature in primary combustor 50 or may measure a temperature of an element or area from which the temperature in the primary combustor 50 may be inferred.

Although fuel flow adjustment is conventionally perceived as a technique for adjusting operating speed with the resultant temperature being a direct function of the fuel flow and therefore the speed, the integrated turbogenerator system of the present invention advantageously decouples speed and temperature by controlling speed to a value selected in accordance with the power to be provided and by separately controlling the temperature to a value selected for optimized performance.

A second control loop, speed control loop 216, controls speed of the shaft common to the turbine 70, compressor 40, and motor/generator 10, hereafter referred to as the common shaft, by varying torque applied by the motor generator to the common shaft. Torque applied by the motor generator to the common shaft depends upon power or current drawn from or pumped into windings of motor/generator 10. Bi-directional generator power converter 202 is controlled by rotor speed controller 216C to transmit power or current in or out of motor/generator 10, as indicated by bi-directional arrow 242. A sensor in turbogenerator 1 senses the rotary speed on the common shaft and transmits that rotary speed signal over measured speed line 220. Rotor speed controller 216 receives the rotary speed signal from measured speed line 220 and a rotary speed set point signal from a rotary speed set point source 218. Rotary speed controller 216C generates and transmits to generator power converter 202 a power conversion control signal on line 222 controlling generator power converter 202's transfer of power or current between AC lines 203 (i.e., from motor/generator 10) and DC bus 204. Rotary speed set point source 218 may convert to the rotary speed set point a power set point P* received from power set point source 224.

For example, at start up, shut down, or during other transient conditions when the rotational power applied to the common shaft from the exhaust gasses of the combustor is not sufficient to achieve or maintain the desired speed, power is applied via DC bus 204 to motor/generator 10 to increase the speed of the turbine. A sensor in turbogenerator 1 senses the rotary speed on the common shaft and transmits that rotary speed signal over measured speed line 220. Rotor speed controller 216 receives the rotary speed signal from measured speed line 220 and a rotary speed set point signal from rotary speed set point source 218. Rotary speed controller 216 generates and transmits to power converter 202 a power conversion control signal on line 222 controlling power converter 202's transfer of power or current between AC lines 200 (i.e., from motor/generator 10) and DC bus 204. Rotary speed set point source 218 may convert the rotary speed set point to a power set point P* received from the power set point source 224.

In a preferred embodiment, speed command receives an indication of the power being applied or to be applied by power converter 202 to load/grid 208. In this manner, the rotor speed of integrated turbogenerator system is maintained in a closed loop feedback control in accordance with the power being, or to be provided, to the load.

A third control loop, voltage control loop 234, controls bus voltage on DC bus 204 to a set point by transferring power or voltage between DC bus 204 and any of (1) Load/Grid 208 and/or (2) energy storage device 210, and/or (3) by transferring power or voltage from DC bus 204 to dynamic brake resistor 214. A sensor measures voltage DC bus 204 and transmits a measured voltage signal over measured voltage line 236. Bus voltage controller 234C receives the measured voltage signal from voltage line 236 and a voltage set point signal V* from voltage set point source 238. Bus voltage controller 234C generates and transmits signals to bi-directional load power converter 206 and bi-directional battery power converter 212 controlling their transmission of power or voltage between DC bus 204, load/grid 208, and energy storage device 210, respectively. In addition, bus voltage controller 234 transmits a control signal to control connection of dynamic brake resistor 214 to DC bus 204.

Power controller 201 regulates temperature to a set point by varying fuel flow, adds or removes power or current to motor/generator 10 under control of generator power converter 202 to control rotor speed to a set point as indicated by bi-directional arrow 242, and controls bus voltage to a set point by (1) applying or removing power from DC bus 204 under the control of load power converter 206 as indicated by bi-directional arrow 244, (2) applying or removing power from energy storage device 210 under the control of battery power converter 212, and (3) by removing power from DC bus 204 by modulating the connection of dynamic brake resistor 214 to DC bus 204.

During operation of the integrated turbogenerator system of the present invention, a measured bus voltage is compared to a preselected or commanded DC bus voltage V* and a voltage error is generated which is applied to a battery power converter, a brake resistor, and/or a load power converter. If the measured bus voltage drops, the amount of power being removed via DC bus 204 for application to load/grid 208 may be reduced by operation of load power converter 206. Power may be applied from load/grid 208 if an energy source is included therein, in order to prevent the drop in voltage on DC bus 204. Further, power may be applied to DC bus 204 from energy storage device 210 under the direction of battery power converter 212 to prevent the drop in voltage on DC bus 204. If measured bus voltage 236 begins to exceed commanded DC bus voltage V*, power may be removed from DC bus 204 to limit the voltage increase by applying more power to DC bus 204 from load/grid 208 under the control of load power converter 206, or by applying power to energy storage device 210 under the control of battery power converter 212, or by dissipating excess power in brake resistor 214 which may be modulated on and off under the control of DC bus voltage control loop 234.

Thus, power controller 201 of the present invention regulates the turbine temperature to a set point by varying fuel flow, adds or removes power or current to motor/generator 10 under the control of generator power converter 202 to control the rotor speed to a set point, and controls a bus voltage to a set point by (1) applying or removing power from DC bus 204 under the control of load power converter 206, (2) applying or removing power from energy storage device 210 under the control of battery power converter 212, and (3) by removing power from DC bus 204 by modulating the connection of dynamic brake resistor 214 to DC bus 204.

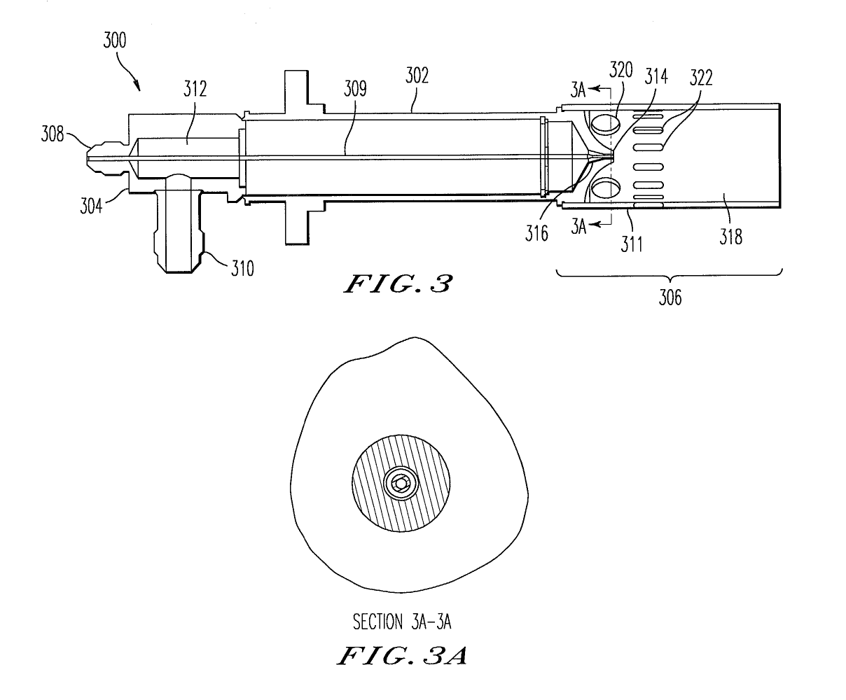

Referring to FIG. 3, it shows a fuel injector 300 through which fuel and air may be delivered to the combustor. The fuel injector generally comprises an outer injector tube 302 having an inlet end 304 and a discharge end 306. Inlet end 304 of the injector includes a fuel coupler 308 having a small centrally located tube that carries fuel to the atomizer face 314 and air coupler 310 communicating with annular space 312 between central fuel injector tube 309 and outer injector tube 311. Annular air discharge area 318 is formed in part at the atomizer face by the small end of a truncated conical insert 316 having the same axis as the central fuel injector tube. Outer injector tube, 311 having a plurality of air supply holes 320 and slots 322 just downstream of the atomizer face, continues beyond atomizer face 314 to discharge end 306 of fuel injector 300. During operation, fuel and air are fed into the injector couplings and air is fed into the air supply holes. Atomization begins at and continues downstream of the atomizer face. Fine droplets resulting from atomization promote mixing and provide intimate contact between fuel and air. The mixture reaching the discharge end of the injector tube is inflammable and ready for ignition when it is ejected into the combustor.

Additionally or alternatively, the nozzle orifices can be actively varied in terms of size and/or geometry to affect a change in fuel droplet size. Droplet size is influenced by atomizer orfice size and relative fuel jet velocity. Within velocities ranges of interest in the invention, droplet size is a stronger function of orifice size at the low end of the range (i.e., lower turbine speeds), but may transition to a regime where the orifice size influence is slight at the high end of the range (i.e., higher turbine speeds).

In turbines utilizing air assist or air blast atomizers, the amount of air supplied to these atomizers may also be controlled to vary the fuel droplet size emitted from the atomizers. Air to the atomizer may be supplied during operation of the turbine engine compressor. Other air may be supplied by a different compressor, which may be similar to the helical flow compressor described in U.S. Pat. No. 5,899,672. The entire contents of U.S. Pat. No. 5,899,672 are incorporated herein by reference. The air compressor of the present invention may be similar to the air compressor described in U.S. Pat. No. 5,819,524. The entire contents of U.S. Pat. No. 5,819,524 are incorporated herein by reference.

The fuel jet is surrounded by air as it leaves the nozzle. The relative velocity between fuel and air creates disrupting forces on the fuel stream. For fixed geometries, relative velocities generally increase with increased mass flow. At lower velocities in the range, this disruptive force first tears the fuel jet into shreds and later breaks the shreds into droplets. At higher velocities in the range, the momentum transfer from air to fuel produces a more or less instantaneous conversion of the coherent stream to a spray of droplets. The compressor of the present invention is configured to air assist atomize (or air blast atomize) the injected fuel mixture. Such compressors are configured, according to the present invention, to compress the incoming air with the airblast and control the degree of atomization by the amount of air added to the injected fuel.

Fuel droplet size atomization, according to the present invention, is preferably controlled by varying the fuel supply pressure. By varying the fuel supply pressure, the speed at which the fuel is injected through the injector nozzles varies and affects the mixing and atomization of the fuel. Mass flow through a fixed orifice is influenced by the fuel supply pressure. Increasing the supply pressure increases the mass flow. Velocity increases accompany mass flow increases. Fuel jet velocity increases lead to higher relative velocities between the fuel jet and the surrounding air. Fuel pressure supply increases therefore lead to larger disruptive forces acting on the fuel jet to overcome surface tension and therefore smaller mean fuel droplet diameters. Although the fuel is typically supplied via a fuel pump, the flow and pressure of the liquid fuel can also be controlled by a liquid fuel pressurization and control system as described in U.S. Pat. No. 5,873,235. The entire contents of U.S. Pat. No. 5,873,235 are incorporated herein by reference.

The fuel cycle in the turbogenerator of the present invention can be described in terms of five consecutive steps:

(a) preparing the fuel prior to atomization,

(b) atomizing the fuel,

(c) vaporizing the fuel,

(d) mixing the fuel with an oxidizer (i.e. air), and

(e) combusting the fuel/air mixture.

The present invention entails active control of any combination of steps (a) through (d) above in response to the instantaneous turbine speed to achieve a desired balance between combustion stability and combustion efficiency.

With greater particularity, one method of the present invention is directed to active control of the fuel droplet size following fuel atomization. By controlling the fuel droplet size, the temperature of the ensuing combustion reaction can be controlled. Thus, at lower turbine speeds, the fuel droplet size may be increased to counteract the effect of a lower fuel-to-air ratio as described above, and to thereby maintain the combustion temperature at a self-sustaining level. As the turbine speed increases, the fuel droplet size may be once again decreased to more fully atomize the fuel, maintaining efficient combustion at the reduced turbine speed.

The invention can use any method known in the art to actively vary fuel droplet sizes. Possible methods according to the present invention, offered as illustrative examples only and not meant in any way to limit the scope of the invention, are discussed below.

In one embodiment of the invention, the fuel droplet size is controlled by heating or cooling the fuel prior to fuel injection to increase or decrease, respectively, the fuel droplet size. Formation of droplets occurs when disruptive forces acting on the fuel jet overcome the surface tension which tends to maintain the fuel jet agglomeration. Heating the fuel leads to a reduction in surface tension and therefore to smaller mean droplet sizes if other factors remain the same.

The fuel, according to the present invention, can also be electrostatically charged and, by varying the voltage at which the fuel is charged, the fuel droplet size is varied. A fuel jet may be atomized when it passes through an electric field. Droplet size is a strong function of the number of charges imparted to the droplets. Field strength and distances between droplets and charged surfaces strongly influence the charge imparted to droplets.

Within the step of mixing the fuel, the electromagnetic field applied inside the combustor to control the fuel droplet size in turn influences the speed and rate at which the fuel droplets mix with the oxidizer.

Mixing can also be controlled, according to the present invention by varying the geometry of the fuel injection. One way, according to the present invention, of varying the geometry is to change the orientation of the injection nozzles with respect to the angle of entry of the fuel in the air stream. Mixing can also be controlled, according to the present invention, by injecting fuel separately or coincidentally from injector orifices having different openings and/or different shapes.

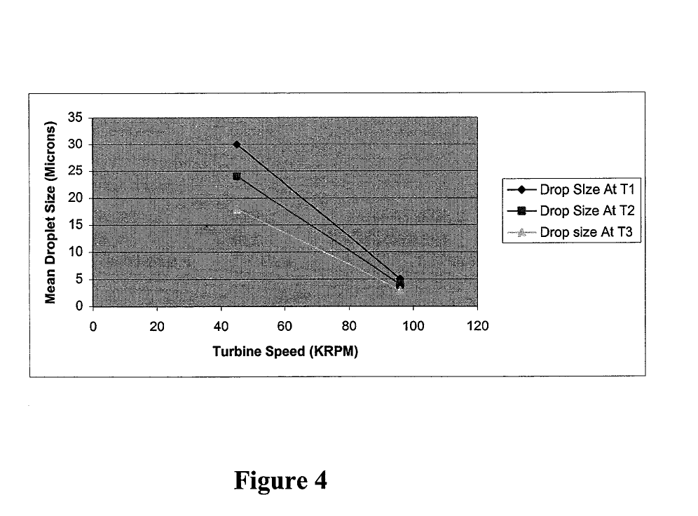

Referring to FIG. 4, it shows an example of one such active control of mixing and/or fuel droplet size by varying the amount of heat input to liquid fuel prior to atomization; FIG. 4 is a graph depicting fuel droplet distribution size as a function of turbine speed for different input heating of the fuel. As the turbine speed increases from idle to fall power, the diameter of fuel droplets typically decreases. For a given nozzle size, as the heat input to the liquid fuel is increased (i.e in the direction of arrow 55), the droplet size variation curve shifts as shown by curve A 51, curve B 52, curve C 53, and curve D 54. Higher input heat produces for the same rotation speed a smaller droplet size.

Thus, according to one embodiment of the present invention, active control of the heat input involves an operating path 56 that maintains droplet size above a predetermined turbine speed and below that predetermined turbine speed provides larger droplet sizes to increase the fuel droplet size to prevent flame-out.

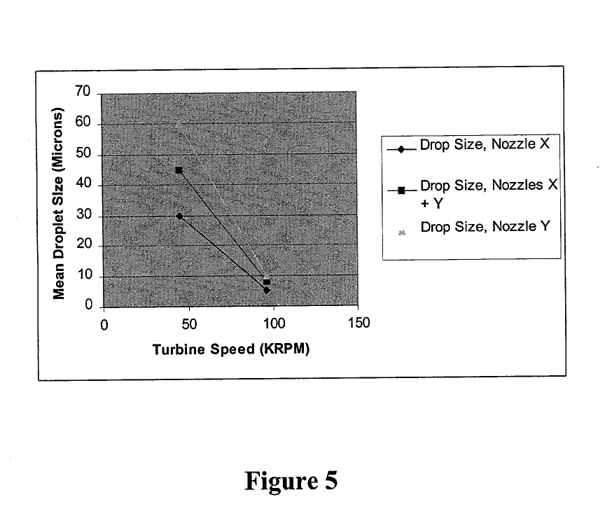

Referring to FIG. 5, it shows another example of active control that varies orifice diameters of inlet nozzles; FIG. 5 is a graph, according to the present invention, depicting performance curves for nozzles with different orifices used separately and in combination. According to this embodiment of the present invention, for a given heat input to liquid fuel, active control would involve switching from performance curve 63 of Nozzle Y to a performance curve 62 of a combination of nozzles X and Y, and then to a performance curve 61 of nozzle X with a resulting operating path 64, as shown in FIG. 3. Nozzles X and Y differ only because the atomizer orifice size is different.

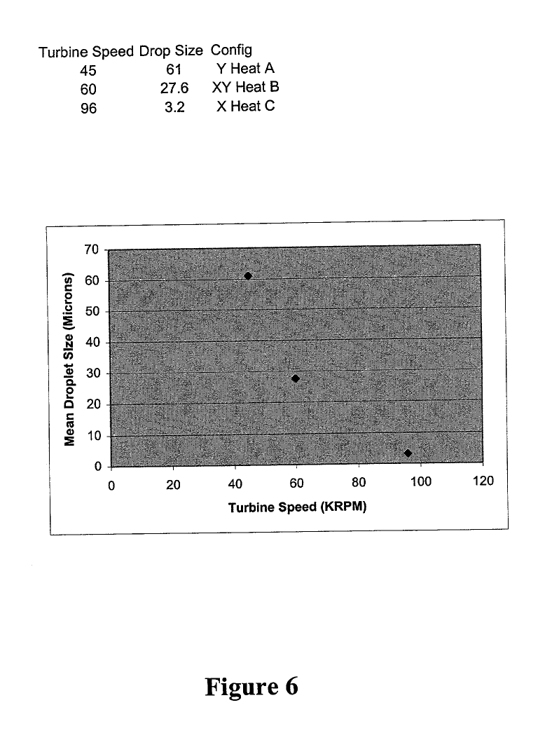

Referring to FIG. 6, it shows an active control of two combustion parameters; FIG. 6 is a graph depicting a combined performance curve for nozzle size and input heat variation. According to this embodiment of the present invention, an optimal operating path 71 is obtained by varying simultaneously the nozzle sizes and the heat input to the liquid fuel. The resulting performance is obtained by combining the performance curves in FIG. 3 with the performance curves in FIG. 4 to derive the operating path 71. The examples above show active control of nozzle sizes and heating of fuel. However, the invention is equally applicable to variation and control of other combustion parameters, either controlled individually or in combination with others.

The method of active control, according to the present invention, can be both open loop, based on a model, and/or system knowledge, or closed loop based on measurements and feedback.

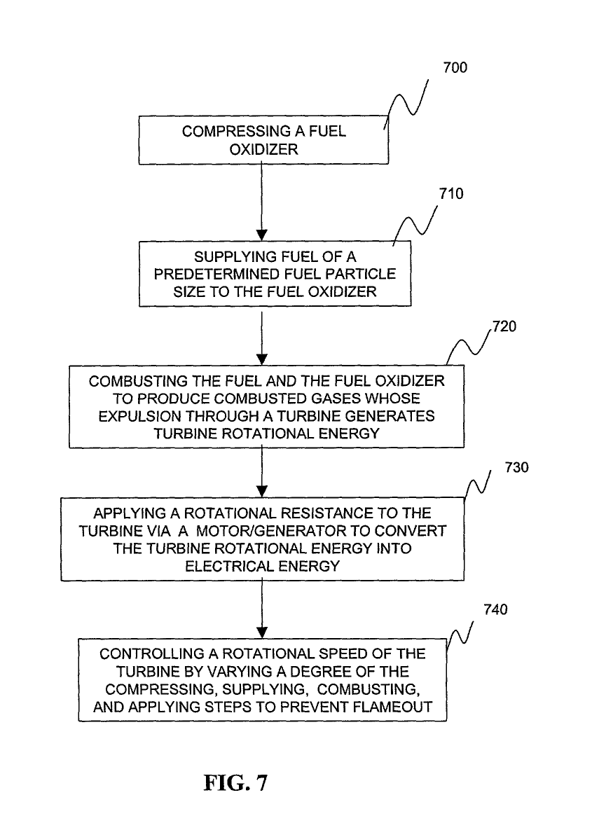

Referring to FIG. 7, it shows a flowchart depicting steps to be controlled in operating the turbogenerator of the present invention. The steps include, at step 700 compressing the fuel oxidizer, at step 710 supplying to the fuel oxidizer a fuel with a controllable droplet size to prevent flameout of the turbogenerator, at step 720 combusting the fuel and the compressed fuel oxidizer to produce combusted gases whose expulsion through a turbine generate turbine rotational energy, at step 730 applying a rotational resistance to the turbine via a motor/generator to convert the turbine rotational energy into electrical energy, and at step 740 controlling a rotational speed of the turbogenerator by varying a degree of the compressing, supplying, combusting, and applying steps to prevent flameout of the turbogenerator.

Compressing step 700 can supply an air blast of the fuel oxidizer.

Supplying step 710 can inject the fuel through at least one variable orifice configured to vary entry angles of the fuel droplets to change a degree of fuel/fuel-oxidizer mixing, can inject the fuel through orifices differing in at least one of an opening size and a shape, can inject the fuel into a combustor having an electric field, and can inject fuel which has been heated or cooled.

Combusting step 720 can vary a fuel/fuel-oxidizer ratio to control a turbine temperature.

Applying step 730 can introduce an electrical load onto the motor/generator. The electrical load can include at least one of a load-line power converter connected to a power grid, an energy storage device connected to at least one battery via a battery power converter, and a dynamic brake resistor. The electrical load can remove (or add) power from (or to) the motor/generator.

Controlling step 740 can control the rotational speed to a predetermined speed set point.

The disclosed embodiments of the present invention have been described in conjunction with turbines. However, it must be understood that the invention is equally applicable to other combustion systems that utilize liquid fuel. Additionally, elements of any of the embodiments described above may be used independently with, or in conjunction with, any of the elements in other embodiments to achieve the desired balance between turbine efficiency and stability.

Obviously, additional modifications and variations of the present invention are possible in light of the above teachings. It is therefore to be understood that within the scope of the appended claims, the invention may be practiced otherwise than as specifically described herein.

1. A turbogenerator, comprising:
a compressor configured to compress a fuel oxidizer;
a combustor connected to an exhaust of the compressor and configured both to receive the fuel oxidizer and a fuel and to combust the fuel and the fuel oxidizer into a combusted gas;
a fuel supplier configured to control fuel droplet sizes of the fuel supplied into the combustor to prevent flameout of the turbogenerator;
a turbine attached to an exhaust of said combustor and configured to convert heat from the combusted gas into rotational energy;
a motor/generator configured to convert said rotational energy into electrical energy; and
a common shaft connecting said turbine, said compressor, and said motor/generator,
wherein said common shaft is configured to rotate said turbine, said compressor, and said motor/generator.

2. The turbogenerator of claim 1, further comprising:
a catalytic reactor downstream of said turbine configured to reduce unburned hydrocarbons in said combusted gases.

3. The turbogenerator of claim 1, further comprising:
a recuperator configured to transfer heat from exhaust gases downstream of said compressor to the intake fuel oxidizer.

4. The turbogenerator of claim 1, further comprising:
a power controller configured to control at least one of a turbine temperature and a turbine speed.

5. The turbogenerator of claim 4, wherein the power controller is configured to control at least one of a supply pressure of the fuel supplier, a first fuel-injection mechanism configured to inject the fuel into the combustor via a variable orifice, a second fuel-injection mechanism configured to inject fuel via separate fuel injectors, a fuel-heating mechanism configured to heat the fuel, a fuel-cooling mechanism configured to cool the fuel, and an electric field inside the combustor.

6. The turbogenerator of claim 1, further comprising:
a power controller configured to control a current between the motor/generator and an electrical load.

7. The turbogenerator of claim 6, wherein the electrical load comprises at least one of:
a load-line power converter connected to a power grid;
an energy storage device connected to at least one battery via a battery power converter; and
a dynamic brake resistor.

8. The turbogenerator of claim 7, wherein the dynamic brake resistor is configured to be selectively applied to remove power from the motor/generator.

9. The turbogenerator of claim 6, wherein the power controller comprises:
a bi-directional generator power converter connected between said motor/generator and a DC bus and configured to convert AC power from said motor/generator for application to said DC bus and to convert DC power from said DC bus for application to said motor/generator.

10. The turbogenerator of claim 9, wherein the power controller further comprises:
a speed control loop responsive to a measured value related to a rotational speed of said common shaft and configured to control said rotation speed at a predetermined speed set point by operating said bi-directional generator power converter to apply power from said motor/generator to said DC bus and from said DC bus to said motor/generator.

11. The turbogenerator of claim 1, wherein the compressor comprises:
an air blast unit configured to mix the fuel droplets in an air blast.

12. The turbogenerator of claim 1, wherein the fuel supplier comprises:
at least one fuel injector.

13. The turbogenerator of claim 12, wherein the at least one fuel injector comprises:
at least one variable orifice.

14. The turbogenerator of claim 13, wherein the at least one variable orifice is configured to inject the fuel into the combustor at varying entry angles to change a degree of fuel/fuel-oxidizer mixing.

15. The turbogenerator of claim 1, wherein the fuel supplier comprises:
at least two fuel injectors with orifices differing in at least one of an opening size and a shape.

16. The turbogenerator of claim 1, wherein the fuel supplier comprises:
a mechanism configured to heat the fuel.

17. The turbogenerator of claim 1, wherein the fuel supplier comprises:
a mechanism configured to cool the fuel.

18. The turbogenerator of claim 1, wherein the fuel supplier comprises:
a pre-mixer configured to supply prior to the compressor at least a part of said fuel to the fuel oxidizer.

19. The turbogenerator of claim 1, wherein the fuel supplier comprises:
a fuel conduit configured to supply said fuel to the compressor.

20. The turbogenerator of claim 1, wherein the fuel supplier is configured to adjust a fuel/fuel-oxidizer ratio to control a turbine temperature.

21. The turbogenerator of claim 1, wherein the combustor comprises:
an electric field existing inside the combustor and configured to charge the fuel droplets.

22. The turbogenerator of claim 1, wherein the combustor comprises:
a catalytic combustor configured to combust unreacted hydrocarbons in the combustion gas on catalytic surfaces therein.

23. A method for controlling a turbogenerator, comprising:
compressing a fuel oxidizer;
supplying to the fuel oxidizer a fuel with a controllable fuel droplet size to prevent flameout of the turbogenerator;
combusting the fuel and the fuel oxidizer to produce combusted gases whose expulsion through a turbine generates turbine rotational energy;
applying a rotational resistance to the turbine via a motor/generator, said motor/generator converting the turbine rotational energy into an electrical energy; and
controlling a rotational speed of the turbine by varying a degree of the compressing, supplying, combusting, and applying steps.

24. The method of claim 23, wherein the step of compressing comprises:
supplying an air blast of the fuel oxidizer.

25. The method of claim 23, wherein the step of supplying comprises:
injecting the fuel through at least one variable orifice configured to vary entry angles of the fuel droplets to change a degree of fuel/fuel-oxidizer mixing.

26. The method of claim 23, wherein the step of supplying comprises:
injecting the fuel through orifices differing in at least one of an opening size and a shape.

27. The method of claim 23, wherein the step of supplying comprises:
injecting the fuel into a combustor having an electric field.

28. The method of claim 23, wherein the step of supplying further comprises:
heating the fuel prior to said step of combusting.

29. The method of claim 23, wherein the step of supplying further comprises:
cooling the fuel prior to said step of combusting.

30. The method of claim 23, wherein the step of combusting comprises:
varying a fuel/fuel-oxidizer ratio to control a turbine temperature.

31. The method of claim 23, wherein the step of applying comprises:
introducing an electrical load onto the motor/generator.

32. The method of claim 31, wherein the step of introducing comprises:
introducing at least one of a load-line power converter connected to a power grid, an energy storage device connected to at least one battery via a battery power converter, and a dynamic brake resistor as said electrical load.

33. The method of claim 31, wherein the step of introducing comprises:
removing electrical power from the motor/generator.

34. The method of claim 31, wherein the step of introducing comprises:
adding electrical power to the motor/generator.

35. The method of claim 23, wherein the step of controlling comprises:
controlling the rotational speed to a predetermined speed set point.

36. A power generation and distribution system comprising:
a turbogenerator, including,
a compressor configured to compress a fuel oxidizer,
a combustor connected to an exhaust of the compressor and configured both to receive the fuel oxidizer and a fuel and to combust the fuel and the fuel oxidizer into a combusted gas,
a fuel supplier configured to control fuel droplet sizes of the fuel supplied into the combustor to prevent flameout of the turbogenerator,
a turbine attached to an exhaust of said combustor and configured to convert heat from the combusted gas into rotational energy,
a motor/generator configured to convert said rotational energy into electrical energy, and
a common shaft connecting said turbine, said compressor, and said motor/generator, said common shaft configured to rotate said turbine, said compressor, and said motor/generator; and
an electrical load connected to the turbogenerator.

37. The system of claim 36, further comprising:
a power controller configured to control at least one of a turbine temperature, a turbine speed, and a current between the motor/generator and the electrical load.

38. The system of claim 36, wherein the electrical load comprises at least one of:
a power grid; and
an energy storage device.

39. The system of claim 38, wherein the power grid includes a load-line power converter.

40. The system of claim 38, wherein the energy storage device includes a battery power converter.
